(19) United States
(12) Patent Application Publication
(10) Pub. No.: US 2014/0130509 A1
(43) Pub. Date: May 15, 2014

(54) COMBINED GASIFICATION AND POWER GENERATION

(71) Applicants: Raymond Francis Drnevich, Clarence Center, NY (US); Shrikar Chakravarti, East Amherst, NY (US)

(72) Inventors: Raymond Francis Drnevich, Clarence Center, NY (US); Shrikar Chakravarti, East Amherst, NY (US)

(21) Appl. No.: 14/046,101

(22) Filed: Oct. 4, 2013

Related U.S. Application Data
(60) Provisional application No. 61/725,766, filed on Nov. 13, 2012.

(51) Int. Cl. F01K 23/06; F02C 3/28

(52) U.S. Cl. CPC F01K 23/068; F02C 3/28
USPC 60/780

(57) ABSTRACT

A combined gasification and electric power generation method wherein between 30.0 and 60.0 percent of the compressed air required by an air separation unit supplying oxygen to a gasifier and nitrogen to gas turbine(s) is extracted from a compressor of the gas turbine(s). An installation, including the gas turbine(s), the air separation unit, a gasifier and a gas conditioning system for producing gas turbine fuel, has a design point of ambient temperature and pressure and net power output for producing the electric power required by a captive user. The gas turbine(s), at the design point, have a capacity to compress air from the compressor thereof, at a rate between 4.8 and 6.0 times the total molar flow rate of air required by the air separation unit and the compressor of the gas turbine(s) is operated at no less than 90.0 percent of its capacity at the design point.

### RELATED APPLICATIONS

This application claims the benefit of U.S. Provisional Application Ser. No. 61/725,766, filed on Nov. 13, 2012, which is incorporated herein by reference.

### FIELD OF THE INVENTION

The present invention relates to a combined gasification and electrical power generation method in which a carbonaceous substance is gasified in a gasifier that is supplied with oxygen generated by a cryogenic air separation plant to produce a synthesis gas that, after processing, is used as a fuel for one or more gas turbines that are supplied with nitrogen from the air separation plant and that are in turn used to generate at least part of the electrical power required for a facility and to supply compressed air to the cryogenic air separation plant.

### BACKGROUND OF THE INVENTION

Coal can be gasified and electrical power can be generated in what is known in that art as an integrated gasification and combined cycle (IGCC). In IGCC, gasification of the coal or other carbon containing substance produces a synthesis gas containing mainly hydrogen, carbon monoxide and carbon dioxide with some amount of methane and sulfur and chloride containing impurities. In a typical gasifier the carbonaceous feed is reacted with steam and oxygen to produce the synthesis gas. The carbonaceous material can either be directly fed to the gasifier or as a carbonaceous material-water slurry which is fed to the gasifier. Typically, the oxygen is provided to the gasifier by an air separation unit in which air is rectified within distillation columns at low temperatures to produce the oxygen.

In an integrated gasification combined cycle, the synthesis gas produced as a result of the gasification is cooled to a temperature suitable for its further processing in a COS hydrolysis reactor that hydrolyzes most of the carbonyl sulfide into hydrogen sulfide. The synthesis gas is then further cooled for hydrogen sulfide separation within a solvent scrubbing plant employing physical or chemical absorption for separation of the hydrogen sulfides and carbonyl sulfide from the synthesis gas. The resulting fuel gas is then fed to a gas turbine that is coupled to an electrical generator to generate electrical power. Heat can be recovered by cooling the exhaust from the gas turbine exhaust to raise steam and to generate additional electrical power from a steam turbine.

IGCC system optimizations have historically focused primarily on capital costs and secondarily on efficiency. This focus is particularly germane when there are no limits to the output from the IGCC facility. This is true when the IGCC facility is owned by a utility or an independent power producer where the facility is designed for selling power to the electric power grid.

IGCC systems are also designed to provide electric power to a captive user such as a refinery or a facility designed to produce hydrogen or liquids from coal, pet coke, or other hydrocarbon feedstock and/or to a complex of facilities which may include the production of chemicals such as ethylene oxide. In such cases, the IGCC system may provide utilities such as steam, hot water, boiler feed water, fuel gas, and syngas in addition to electric power. In some cases a source of syngas/fuel gas for the IGCC system can come from the captive user complex. The gross electric power output from the IGCC facility can be limited to that required by the captive user plus that required to operate the IGCC facility (internal uses). Often the option of selling excess power to the grid is impractical due to economic considerations. These considerations include: low price for the excess electric power and the existence of regulations that constrain the seller's ability to operate the IGCC system as is needed to provide only the requirements of the captive customer.

The internal uses include electric power for: conveyors for solids movement, grinders/pulverizers to reduce the size of the solid hydrocarbons prior to feeding to the gasifier, compressors for the air separation units, pumps for the acid gas removal, steam, and other subsystems, blowers and compressors for miscellaneous requirements such as instrument air and startup boilers, lighting, and other miscellaneous uses. The net power from the IGCC facility is defined as the difference between the net power output at the generators minus the internal uses. This net power is supplied to the captive user.

Because of the nature (composition variability and burning characteristics) of syngas generated by commercial gasification systems, gas turbines usually use standard diffusion combustors for burning the fuel gas. NOx emissions are controlled through the use of diluents such as steam and nitrogen from the air separation unit. The diluent reduces the flame temperature of the fuel gas and reduces the level of NOx generated by the turbine combustors. Since the diluent addition can be a significant mass addition to the gas turbine the operation of the gas turbine is impacted.

The gas turbine exhaust is sent to a heat recovery steam generator (HRSG) to generate steam for export to the captive users and/or for generation of electric power in a steam turbine. The amount of power that the steam turbine(s) generate will reduce the power generation requirements from the gas turbine when meeting a fixed level of internal and captive user power requirements. It is important to note that the gasifier capacity and consequently the internal power requirements of the IGCC system is generally set by the fuel required by the gas turbine. The most efficient system is that system (combination of gas turbine, steam turbine, gasifier, and air separation unit) that provides the utilities using the lowest quantity of solid fuel. For a given gasifier type the overall plant efficiency is determine by the gas turbine selected, the steam turbine performance, the design of the air separation unit and the integration between the air separation unit and the gas turbine.

Integration of the air separation unit with the gas turbine include: nitrogen return to the gas turbine for NOx control and often for increasing the output of the gas turbine to near its maximum power rating which is set by the mechanical limits of the machine (called nitrogen integration); air extraction from the gas turbine combustor for use as feed air to the air separation unit with nitrogen return to the gas turbine (called full integration when all the air for the air separation unit is provided by the gas turbine compressor and called partial air integration when only part of the air for the air separation unit is provided by the gas turbine compressor). Generally, since the quantity of nitrogen returned to the gas turbine is a significant portion of the nitrogen available from the ASU (often in excess of 40% of the available nitrogen) the air separation units are designed for producing low purity oxygen (generally at about 95 mole % oxygen) using a design that allows for producing oxygen and nitrogen from distillation columns that are higher pressure than plants where little or no nitrogen is needed for gas turbine injection. The high pressure column in the case where little nitrogen is needed is usually at a pressure less than 100 psia with the low pressure column less than about 20 psia. When large quantities of nitrogen are required the high pressure column pressure can exceed 200 psia and the low pressure column can be in excess of 50 psia. The advantage of the high pressure operation is a reduction in the overall power requirement of the air separation system by reducing the power required to raise the oxygen and nitrogen to the end use pressure (oxygen can be needed at pressures greater than 500 psia and nitrogen at pressures in excess of 200 psia.) The separation power associated with low purity oxygen does not change dramatically with an increase in pressure when 95 mole % purity oxygen is produced. If air is extracted from the gas turbine for use as feed for the air separation unit the discharge pressure of the gas turbine compressor is often used to set the pressure of the high pressure column in the air separation unit.

Nitrogen return to the gas turbine is almost always used in IGCC system. Full integration has been shown to produce the most efficient IGCC system but has the disadvantage of being difficult to startup since the gas turbine needs to be operating at a high rate using a startup fuel for an extended period of time until the air separation unit, gasifier, and downstream processing units are operational. Partial air integration has been considered for IGCC systems that have design ambient temperature below about 70° F. operating at barometric pressures near sea level. A key issue in the decision not to use partial integration is the requirement to maximize gas turbine output at the design conditions for systems designed to sell power to the grid. At higher design ambient temperatures or elevations air extraction reduces the air available to the gas turbine expander and does not permit the turbine to achieve its maximum capacity. At low ambient temperatures more air is available from the gas turbine compressor than is needed to achieve maximum power output and air extraction becomes more viable.

As will be discussed hereinafter, the present invention, among other advantages, provides an IGCC method having a greater overall energy efficiency over prior art methodology.

### SUMMARY OF THE INVENTION

The present invention provides a combined gasification and electrical power generation method. In accordance with such method, an oxygen product stream and a carbon containing substance are introduced into a gasifier and the carbon containing substance is gasified to produce a synthesis gas stream comprising hydrogen and carbon monoxide. The synthesis gas stream is treated in a gas conditioning system to produce a fuel stream by removing particulates and sulfur containing compounds from the synthesis gas stream and recovering heat from the synthesis gas stream. It is understood that optionally, carbon dioxide could be removed as well. The fuel stream is introduced into a combustor of at least one gas turbine and electric power is generated by at least one electric generator coupled to at least one gas turbine. Air is separated in an air separation unit by compressing, purifying and cooling the air to a temperature suitable for its rectification in a distillation column system and then rectifying the air within the distillation column system to produce the oxygen product stream and a nitrogen containing stream. The at least one generator generates the electric power at a required power output to at least in part supply an electric power requirement of a captive user and an installation comprising the gasifier, the gas conditioning system, the air separation unit and a nitrogen product compressor. As used herein and in the claims, the term “captive user” means a facility incorporating the IGCC facility that uses the electric power not used in the IGCC facility and as a result, the electric power is not exported to the grid. Between 30.0 percent and 60.0 percent of the compressed air required by the air separation unit is supplied from a bleed air stream extracted from a compressor of the at least one gas turbine without further compression of the bleed air stream. At least part of the nitrogen containing stream is compressed in the nitrogen product compressor to produce a compressed nitrogen stream. The compressed nitrogen stream is fed into at least one of the fuel stream, the combustor and a location downstream of the combustor, before the expander.

The installation has a design point of ambient temperature and pressure and a nominal net power output. As used herein and in the claims, the term “net power output” means the difference between the net power output at the generator or generators less the internal uses consumed by the installation. This net power is supplied to the captive user. The at least one gas turbine, at the design point, has a capacity to compress air at a rate between 4.8 and 6.0 times the total molar flow rate of air required by the air separation plant and the compressor of the at least one gas turbine is operated at no less than 90.0 percent of the capacity thereof at the design point.

Gas flows from the gas turbine compressor, the fuel, and the diluent are involved in defining the performance of the gas turbine combustor. Nominally about half of the power generated by the gas turbine expander is used to drive the gas turbine compressor. The gas turbine compressor is most efficient when it is operated at its design point. As less air is compressed a larger fraction of the gas turbine expander power goes toward driving the air compressor therefore reducing the overall efficiency of the gas turbine as well as the electric power output at the generator terminal.

In accordance with the present invention, a better match between the gas turbine or turbines and the air separation unit is provided than can be found in the prior art in the context of providing utilities to captive users. When a gas turbine is selected to be able to compress air at a rate of between 4.8 and 6.0 times the total molar flow rate of the air required by the air separation unit, the gas turbine is able to supply air to the air separation unit while operating a point not sufficiently removed from its maximum capacity. At the same time, the extraction of air will in fact increase the gas turbine compressor efficiency as well as reduce the internal power consumption electric power consumption of the installation and fuel consumption will be lowered. Since less fuel is required, less coal or other carbonaceous substance will need to be gasified and therefore, less oxygen will have to be supplied to the gasifier. Since, less oxygen will have to be supplied, the power consumed by the air separation unit will be reduced and the size and power consumption of the equipment used in gas conditioning in the production of the fuel stream will also be reduced as a direct consequence thereof.

Part of the electric power requirement of the facility can also be supplied by another electric generator coupled to a steam turbine supplied with steam generated in a heat recovery steam generator connected to the at least one gas turbine to receive a gas turbine exhaust stream to produce heat within the heat recovery steam generator. Preferably, the rate can be between 4.9 and 5.2 time the total molar flow rate of air required by the air separation plant. Also, the bleed air stream can supply 50.0 percent of the compressed air required by the air separation unit. In a specific embodiment of the present invention, the at least part of the nitrogen containing stream has a preselected flow rate that is sufficient to allow the generator to be driven by the gas turbine to generate the electric power at the required electric output. In this regard, the nitrogen containing stream has a nitrogen flow rate that is preferably about equal to air flow rate of the bleed air stream. In a specific embodiment, the compressed nitrogen stream can be heated by the bleed air stream.

### BRIEF DESCRIPTION OF THE DRAWINGS

While the specification concludes with claims distinctly pointing out the subject matter that Applicants regard as their invention, it is believed that the invention will be better understood when taken in connection with the accompanying drawings in which;

FIG. 1 is a schematic illustration of an IGCC installation that is operated in accordance with a method of the present invention; and

FIG. 2 is a schematic illustration of a facility of a captive user incorporating the IGCC installation shown in FIG. 1.

### DETAILED DESCRIPTION

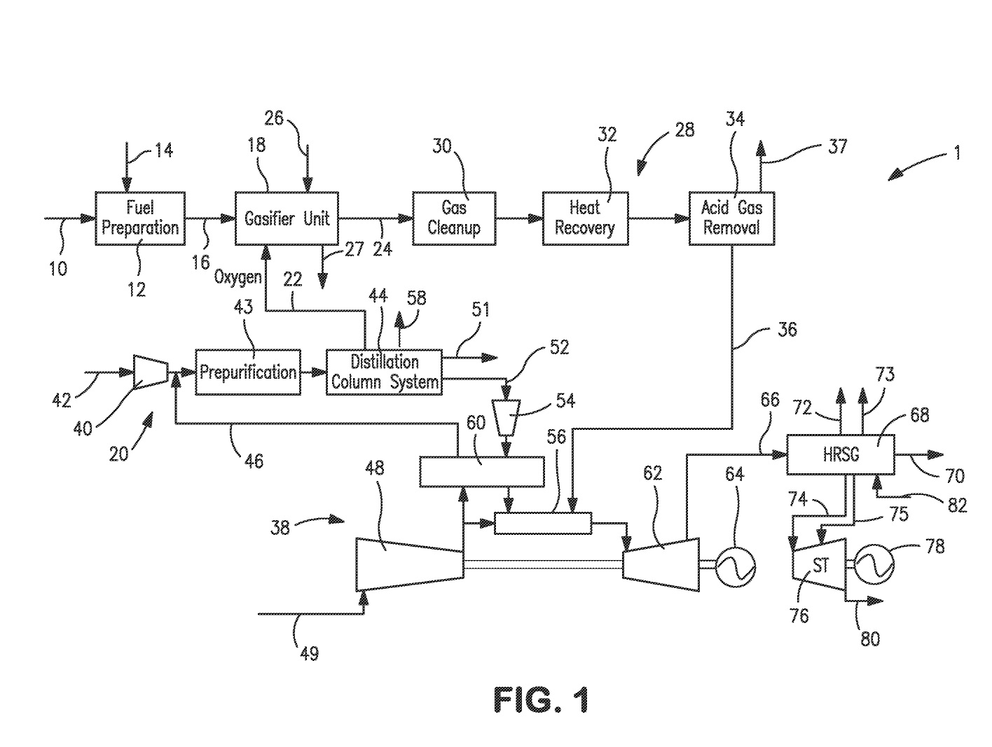

With reference to FIG. 1, an installation 1 is illustrated that is designed to gasify coal 10 and generate electrical power. Such an installation is an IGCC facility.

The coal is typically delivered to the project site by rail or barge and then unloaded by equipment such as trestle bottom dumpers, bucket barge unloaders into receiving hoppers. Coal from the hoppers is fed directly into a vibratory feeder and discharged onto a belt conveyor. Conveyors convey the coal to the coal stacker, which transfers the coal to either the long-term storage pile or to the reclaim area. The reclaimer loads the coal into vibratory feeders located in the reclaim hopper under the pile. The feeders transfer the coal onto a belt conveyor that transfers the coal to the coal surge bin located in the crusher tower. If installation 1 is located in close proximity to the coal mine, the coal receiving and handling subsystem would be simplified. For example, no long-term storage would be required. The coal can be directly conveyed to the coal surge bin located in the crusher tower. A conveyor then transfers the coal to a transfer tower, from where the coal is eventually loaded into silos.

The coal from the silos is then fed onto a conveyor by vibratory feeders located below each silo. The conveyor delivers the coal 10 to a fuel preparation system 12 which may include one or more rod mill feed hoppers. Typically, the feed hopper is sized to provide a surge capacity of about two to eight hours. The hopper outlet discharges onto a weigh feeder, which in turn feeds a rod mill of the fuel preparation system 12. As known in the art, each rod mill is typically sized to process 50-75 percent of the coal feed requirements for gasification. When slurry fed gasifiers are used the rod mill grinds the coal and wets it with treated slurry water 14 transferred from the slurry water tank by the slurry water pumps. The coal slurry is discharged through a trommel screen into the rod mill discharge tank, and then the slurry is pumped to the slurry storage tanks. The dry solids concentration of the final slurry is typically in the range of 50-75%. The coal grinding system is equipped with a dust suppression system consisting of water sprays aided by a wetting agent. The degree of dust suppression required depends on local environmental regulations. All of the tanks are equipped with vertical agitators to keep the coal slurry solids suspended. The equipment in the coal grinding and slurry preparation system is fabricated of materials appropriate for the abrasive environment present in the system. The tanks and agitators are rubber lined. The pumps are either rubber-lined or hardened metal to minimize erosion. The slurry 16 is then fed to a gasifier unit 18 which may comprise one gasifier or a plurality of gasifiers connected in parallel.

Alternatively dry feed gasifiers can be used (not shown) that use lock hoppers for solids pressurization and use nitrogen, carbon dioxide, and, in some cases, syngas to transport the solids into the gasifier. In dry feed gasifiers steam is used to moderate the reaction temperature within the gasifier. Gasifiers for different types of carbonaceous feed materials, e.g. coal, petcoke, are well known in the art. The configuration can be fluidized bed, moving bed or entrained flow. Most coal gasifiers are of the entrained-flow type especially for higher ranking coals. For lower grade coals with high ash content, fluidized bed gasifier may be a preferred option. However, the gasifier unit 18 illustrated herein is an entrained flow slurry fed gasifier.

Operating pressures for entrained flow coal gasifiers, typically range from 300.0 to 1500.0 psig and more typically from 500.0 to 1100.0 psig.

The gasifier unit 18 converts the coal, petroleum coke, or similar hydrocarbon feed material to hydrogen and carbon monoxide containing syngas.

A slurry feed pump takes suction from the slurry run tank, and the discharge is sent to the burner of the gasifier contained in the gasifier unit 18. An air separation plant 20 supplies oxygen by way of an oxygen containing stream 22 to the burner of gasifier unit 18. High purity (greater than 99.8%) or low purity (greater than 95 mol. %) oxygen can be utilized by the gasifier unit 18. In FIG. 1, the air separation plant 20 produces low purity oxygen, namely 85.0 mol percent and greater but less than 99.8 mol percent. Carbon conversion in the gasifier unit 18 is generally quite high and can be about 98 percent.

As would be known to those skilled in the art, the gasifier unit 18 will include a gasifier vessel that is a refractory-lined, high-pressure combustion chamber. The coal slurry 16 and oxygen containing stream 22 are fed through a burner. The coal slurry 16 and the oxygen react in the gasifier unit 18 such that there is not a complete oxidation to water and carbon dioxide. Temperatures can be in excess of about 2,400° F. A hydrogen and carbon monoxide containing stream 24, referred to as syngas or synthesis gas, is generated by breakdown of the solid carbonaceous feed material. In addition to hydrogen and carbon monoxide, the syngas after cooling and water removal also contains lesser amounts of water vapor and carbon dioxide, and small amounts of hydrogen sulfide, carbonyl sulfide, methane, argon, and nitrogen. The heat in the gasifier liquefies coal ash. Hot syngas and molten solids from the reactor flow into a quench section where the syngas is cooled with incoming quench water stream 26. Other means of cooling can also be deployed, e.g. radiant heat exchange. While the syngas exits the gasification section of the gasifier at generally greater than 1500.0° F. and often greater than 2400.0° F., the actual temperature of the syngas leaving the quench and/or heat recovery sections can be much lower than 1500.0° F., e.g. 400.0°-800.0° F. A slag handling system (not shown) stores and disposes slag 27 removed from the gasification process.

A series of unit operations are then conducted which are collectively referred to as gas conditioning system 28. Depending on the feedstock, the type of gasifier and gasifier operating conditions, the impurities may include particulates, tars, acid gases such as carbon dioxide, ammonia, sulfur containing species, and other inorganic substances such as alkali compounds. Impurities may be removed in one unit operation or in a series of unit operations to remove specific contaminants. The gas conditioning system 28 typically employs known technologies. For example, the gas cleanup unit 30 utilizes technologies well known in the art: scrubbers, cyclones and filters to remove particulates; COS hydrolysis units for conversion of COS to H₂S. The gas conditioning system 28 also includes the required cooling of the gasifier-syngas in heat recovery section 32, which could consist of multiple heat exchangers (e.g. boilers, economizers). Generally, steam is produced in a portion of the gas cooling section for use in other parts of the process. The specific details of such operations are well known to those skilled in the art. Also, while not explicitly depicted in FIG. 1, some of the unit operations in the gas cleanup section 30 may be preceded by some of the heat exchangers in heat recovery section 32. After heat recovery in heat exchangers 32, acid gas removal for removal of sulfur compounds and/or CO₂ is performed in acid gas removal unit 34 which can be accomplished through a number of commercially available technologies. These include processes using physical solvents, chemical solvents (e.g. amines) and physical adsorbents (e.g. PSA, VPSA) for bulk removal of sulfur compounds and/or CO₂. Acid gas removal unit 34 may also contain adsorbent beds for polishing removal of sulfur and other contaminants from the syngas to levels acceptable for the gas turbine system. Use of an entrained flow gasifier, where the gasifier-syngas exits the gasification section of the gasifier at generally greater than 1500.0° F. and often greater than 2400.0° F., reduces the complexity of gas conditioning system 28. In particular, tar and methane content of syngas from an entrained flow gasifier tends to be quite low to non-existent. The gas conditioning system 28 so processes the hydrogen and carbon monoxide containing stream 24 to produce a fuel stream 36 that contains hydrogen and carbon monoxide that is fed to a gas turbine 38. An acid gas stream 37 is discharged from the acid gas removal unit 34.

The air separation unit 20 can consist of a multistage compression system 40 with interstage cooling to compress the air stream 42. Air contained in air stream 42, after compression, is purified in a pre-purification unit 43 having adsorbent beds operating in accordance with an out-of-phase pressure swing or temperature swing adsorption cycle for removal of higher boiling impurities, for example carbon dioxide and water vapor. The resulting compressed and purified air is then cooled to a temperature suitable for its distillation within a heat exchanger and then rectified within a distillation column system 44. In order to compensate for heat leakage into a cold box housing the distillation column and warm end losses from the heat exchanger, a turboexpander is also included to generate an exhaust stream. This exhaust stream can be generated by further compressing the air in a booster compressor and then introducing the air into an upper or lower column expander or can be a nitrogen expansion cycle where part of the nitrogen containing stream is expanded and then introduced back into the heat exchanger. The foregoing elements, although not illustrated would be incorporated into the air separation unit 20.

In the embodiment shown in FIG. 1, the air separation unit 20 supplies low purity (95.0 mol. %) oxygen as the oxygen containing stream 22 to the gasifier unit 18 at a pressure that is between 100.0 and 250.0 psia in excess of the gasifier operating pressure. Although not illustrated, this can be conventionally accomplished by pumping a stream of oxygen-rich liquid to pressure and then heating such stream in a heat exchanger of the air separation unit 20 to ambient temperature through indirect heat exchange with part of the air to be separated that has been boosted to high pressure. A bleed stream portion 46, produced by gas turbine 38, constitutes part of the air fed to the air separation unit 20, typically between 30.0 percent and 60.0 percent of the air required for the air separation unit. The bleed stream is extracted from the compressor 48 of the gas turbine system that in the known operation thereof, compresses ambient air 49. This reduces both size and the number of compressors in the air separation unit 20 as well as the power requirements of the compressors associated with such a plant. In addition to low purity oxygen, the particular air separation unit 20 also produces a high purity nitrogen stream 51 and a waste nitrogen 52. The waste nitrogen stream 52 is compressed in a nitrogen compressor 54 to between 200.0 and 500.0 psia and injected into the combustor 56 of the gas turbine system 38. Although all of the waste nitrogen produced by air separation unit 20 can be used for such purposes, typically only a portion thereof will be so used and the waste nitrogen not used for such purposes is vented as a vent stream 58. As illustrated, the bleed air stream 46 can be passed in indirect heat exchange with the waste nitrogen stream 52 in a heat exchanger 60, after compression thereof in nitrogen compressor 54 to further heat the waste nitrogen stream 52 and to cool the bleed air stream 46. It is understood that although the plant can produce both high purity nitrogen and waste nitrogen, embodiments of the present invention are possible in which the air separation unit 20 only produces high purity nitrogen or waste nitrogen for injection into the combustor 56 of the gas turbine 38.

Gas turbine system 38 is selected from commercially available turbines manufactured by a variety of companies known in the art. The particular machine illustrated is an axial flow and constant speed unit with variable inlet guide vanes. The selected turbine typically includes advanced bucket cooling techniques, compressor aerodynamic design and advanced alloys that allow for higher firing temperatures. Gas turbines are typically designed for firing with natural gas but can also be fired with lower-Btu IGCC derived syngas fuel gas stream 36. This will require some modifications to properly combust the syngas in combustor 56 and expand the combustion products in an expander 62 of the machine. These include redesign of the burners in the combustor in a manner known in the art. Although only one of such gas turbines 38 are shown, in a practical application of the present invention, two or more gas turbines could be used.

Inlet air is compressed in compressor 48 to between 140.0 and 350.0 psia. As mentioned above, a portion of the compressor discharge air, bleed air stream 46 which is preferably between 30.0 percent and 60.0 percent of the compressed air requirements of the air separation unit 20 is extracted. The remainder of the discharge air passes to the combustor 56 to support combustion of the syngas. Pressurized syngas, typically fed to the flow control system of the gas turbine at pressures that are more than 100 psi above the compressor discharge pressure, is combusted in several parallel diffusion combustors that would be included within the combustor 56. Again, as indicated above, typically a portion of the waste nitrogen produced by the air separation unit 20, typically between 40.0 percent and 75.0 percent, is compressed to about 20-100 psi above the gas turbine compressor discharge pressure within nitrogen compressor 54, heated to within about 50-100° F. of the temperature of the extracted air using the extracted air within heat exchanger 60 and fed to the combustor 56. In this regard, the compressed waste nitrogen can be fed into the combustor 56, either directly into the combustor or upstream of the combustor 56, or into the fuel stream 36 prior to entering the combustor 56 or downstream from the combustor 56 prior to a expander 62 of the gas turbine or a combination thereof. The hot combustion products, produced at a pressure of between 135.0 and 340.0 psia and a temperature of between 2000.0° F. and 2600° F., are expanded in the expander 62 to generate electrical power in a generator 64 mechanically coupled to the gas turbine 38.

Heat can be preferably recovered and steam generated by the flue gas contained in the exhaust stream 66 produced in the gas turbine 38 by means of a heat recovery steam generator 68 “HRSG”. The HRSG 68 is a horizontal gas flow, drum-type, multi-pressure design that is matched to the characteristics of the gas turbine exhaust gas when firing IGCC syngas. Flue gas, contained in exhaust stream 66, leaving the gas turbine 38 is around 1050° F. and is conveyed through the HRSG 68 to recover the thermal energy and exits the HRSG 68 at 250° F.-400° F. as stack gas 70.

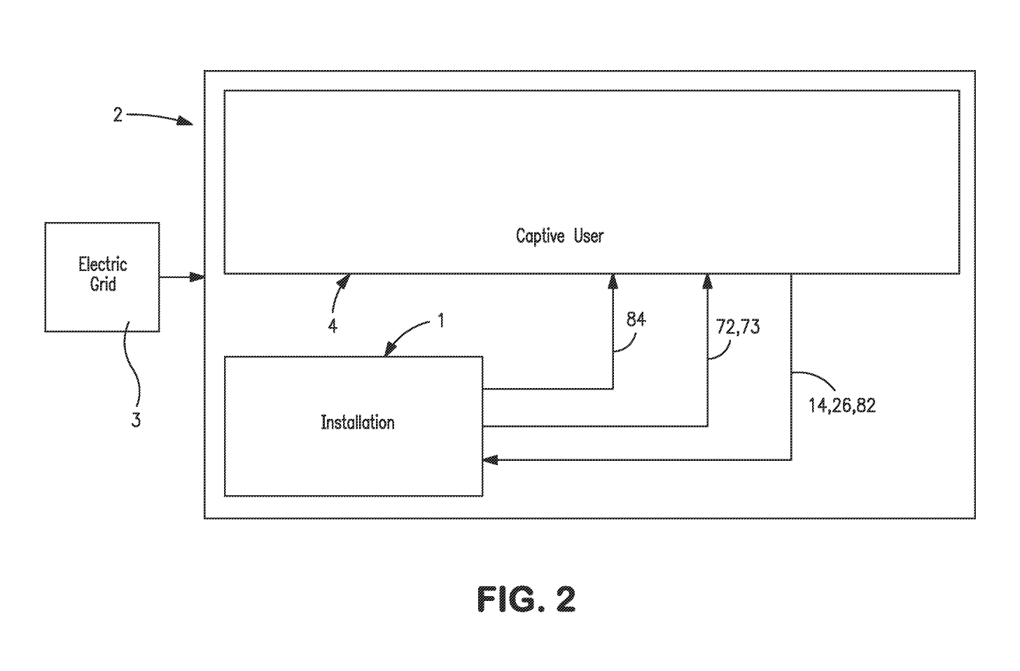

HRSG 68 includes a high pressure (HP) drum that produces steam at about 900-2,000 psig. This steam is superheated to 950°-1050° F. Export steam stream 72 can be produced for use within the facility 2 shown in FIG. 2. Additionally, an intermediate pressure (IP) steam stream 73 can be produced, superheated and exported as export stream for use within the overall complex. The remainder of the steam is sent as a high pressure steam stream 74 and an intermediate pressure steam stream 75 to a steam turbine 76.

In addition to generating and superheating steam, the HRSG 68 performs reheat duty for the cold/hot reheat steam for the steam turbine 76, provides condensate and feed water heating, and also provides heat for deaeration of the condensate. Natural circulation of steam is accomplished in the HRSG 68 by utilizing differences in densities due to temperature differences of the steam. The drums contained in the HRSG 68 include moisture separators, internal baffles, and piping for feed water/steam. All tubes, including economizers, superheaters, and headers and drums, are equipped with drains.

Steam turbine 76 often consists of a high pressure section, an intermediate pressure section and a low pressure section, all connected to an electrical power generator 78 by a common shaft. Steam is exhausted as condensate 80 from a condenser (not shown) at about 2.5 psia and 130° F. While the foregoing use of exhaust gas stream 66 would be the norm, as could be appreciated by those skilled in the art, embodiments of the present invention are possible in which such power is solely generated by the gas turbine 38.

Although not illustrated, but as would be known to those skilled in the art, utility subsystems would be provided for use in connection with installation 1. Such utility subsystems would process several offsite items including water supply and treatment, water management, cooling water supply, condensate treatment, deaeration, wastewater treatment, solid waste management, air emissions management, coal receiving and storage, coal drying for the case of dry feed gasifiers. In facility 2 (see FIG. 2) such utility subsystems would be present within captive user 4. Further, such utility subsystems provide water stream 14 used in preparation of the coal slurry 16, water stream 26 for use as quench in gasifier 18 as well as deaerated boiler feedwater 82 to the heat recovery steam generator “HRSG” 68.

With reference to FIG. 2, a facility 2 is illustrated as an example of the type of facility that would incorporate installation 1 and a captive user 4 of the electrical power 84 generated in electrical generators 64 and 78 that is not consumed in installation 1. In this regard, in installation 1, part of the electric power generated is consumed in air separation unit 20, nitrogen compressor 54, compressors and pumps used in coal preparation 12, gasification 18 and gas conditioning operations 28 and a variety of other miscellaneous uses such as in instrumentation. While the electric grid 3 may be used for such purposes of backup and startup of all elements contained in facility 2, once installation 1 were brought on line, the electric power would no longer be drawn from the electric grid 3. The captive user 4 could conduct such operations as liquid fuel production through Fischer Tropsch technology or methanol synthesis possibly combined with methanol to gasoline (MTG technology), hydrogen production from gasification or steam methane reforming, a refinery chemicals complex to produce methanol, acetic acid, olefins, etc.

Referring again to FIG. 1, the performance of installation 1 is optimized by appropriate gas turbine selection, the amount of air supplied by the gas turbine 38, the operation of gas turbine 38 and the amount of nitrogen 52 used by the gas turbine 38. It is important to note that the installation 1 has a design point of ambient temperature and pressure and gas turbine power output. As to gas turbine power output, the gas turbine selection is based on the total power generation requirements for facility 2, namely, installation 1 and the captive users, namely, the processes taking place as generally designated by reference number 4 in FIG. 2. Where present, steam turbine capacity to generate electrical power is taken into account. Thus, the gas turbine power output is a required power output which when coupled to electrical generator 64 will generate sufficient electrical power for the entire facility 2 taking into account the electrical power that may be generated by steam turbine 76.

Additionally, gas turbine selection is also based on the compressor 48 of the gas turbine 38 used to have sufficient capacity to meet the air flow requirement for the air separation unit 20. In this regard, at design conditions the ratio of the mass of air or in other words, the molar flow rate, that can be compressed at full air compressor capacity to the mass of air required by the air separation unit is between 4.8 and 6.0. (Preferably between 4.9 and 5.2.) It is to be understood that although the foregoing discussion is based on a single gas turbine, the same benefits could be obtained with two or more gas turbines. In such case, the multiple gas turbines would have sufficient compressor performance to comply with such ratios. The selected gas turbine air extraction is set at 50% of the air separation unit air rate and the nitrogen return is set at that needed to provide the required power of the requirements of the IGCC system and the captive customer less electrical power generated by the steam turbine generator 78 if present. If the ratio is greater than 6.0 than a smaller gas turbine will provide optimum performance. At a ratio of 6.0 or larger the gas turbine air compressor will be oversized for air extraction at 50.0 percent of the air separation requirements. The turbine compressor should operate at no less than 90.0 percent of its operating capacity at the design point. At operations below 90.0 percent gas turbine compressor efficiency will degrade. Although, typically, the flow rate of the waste nitrogen stream 52 will be between 60.0 to 110.0 percent of the flow rate of the bleed air stream 46, further efficiencies can be realized when the flow rate of the waste nitrogen stream 52 is about equal to the flow rate of the bleed air stream 46.

For a system operation at a gas turbine design air rate divided the air separation unit design air rate of about 5.0 and no air extraction, the nitrogen addition to the gas turbine combustor for NOx control will reduce the gas turbine compressor air flow to 90% or less of the design air flowrate. At 50% air extraction the same gas turbine air compressor operates at more than 95% of the maximum rate. The nitrogen return rate to ensure that gas turbine power output requirements are met is at least sufficient for NOx control or in other words to reduce NOx in the exhaust gas stream 66 to below about 20 ppmv. The lower limit of the nitrogen return rate may be set based on NOx emissions requirements.

At ratios below 4.8 larger gas turbine should be selected for optimum performance. For example, it has been simulated by the inventors herein that if the ratio is less than 4.6 than a larger gas turbine will have to be selected, since the gas turbine air compressor will be too small to enable effective air extraction. Complete power needs can be provided with no air extraction and nitrogen addition. Overall plant efficiency will be reduced because the internal power needs will be increased versus the air extraction alternative due to the flow requirements of the main air compressor of the air separation plant and the large quantities of nitrogen will be needed for power augmentation.

The following Table is a simulated example showing the benefit of the present invention

TABLE
Steam production
900 psig, 950 F. steam - 150,000 lb/hr
240 psig, 450 F. steam - 300,000 lb/hr

| | | | Electricity Generation | | | Electricity Consumption | | | | |
|---|---|---|---|---|---|---|---|---|---|---|
| | Oxygen | Coal | Gas turbine | | Steam turb. | ASU | N2 compr. | Misc.* | Net power | Efficiency |
| Case | t/d | t/d | Max MW | Actual MW | MW | MW | MW | MW | MW | % |
| 1 | 2926 | 3140 | 300 | 222 | 77 | 30 | 13 | 12 | 244 | 47.0% |
| 2 | 2992 | 3212 | 300 | 240 | 80 | 53 | 10 | 12 | 244 | 45.9% |

| | Bleed Air from GT | | | | Nitrogen to GT | | | | |
|---|---|---|---|---|---|---|---|---|---|
| | T | P | Flow | % feed | T | P | Flow | % of N2 | GT Air/ |
| Case | deg C. | bar | t/h | to ASU | deg C. | bar | t/h | from ASU | ASU Air |
| 1 | 373 | 11 | 269 | 50% | 345 | 15 | 221 | 54% | 5.0 |
| 2 | 374 | 11 | 0 | 0% | 90 | 15 | 174 | 42% | 5.0 |

In both cases two gas turbines were used with one air separation unit 20. Additionally there were two gasification trains, in other words two gasifiers 18 and gas conditioning systems 28 and one HRSG 68 and one steam turbine 76. Also, in both cases, the ratio of the air flow rates to the gas turbine compressors to the air separation unit is 5.0. The gas turbine air compressor flow in case 1 is more than 95.0% of the air flow capacity of the gas turbine at the design conditions (91° F., sea level pressure, and a net plant output of 244 megawatts.) For Case 2 the gas turbine air flow capacity is 90% of that at full capacity at the design conditions. In Case 1, in accordance with the present invention, 50.0 percent of the air compression requirements were supplied from the gas turbines. In Case 2, there was no air extraction from the gas turbines. As is apparent, the gas turbine output in Case 1 was 222.0 megawatts versus a maximum possible power output of 300.0 megawatts and 54 percent of the waste nitrogen produced by the air separation unit 20 was returned to the gas turbines. As is also apparent, the power consumed by the air separation compressors in case 2 was greater than in Case 1 and the overall efficiency was less. Consequently, the electric power needed to be generated by the gas turbine in case 1 is less than in case 2 resulting in a lower coal use rate for case 1. In this regard, the energy efficiency was determined on the basis of the energy contained in the electric power (thermal energy equivalent) and the thermal energy contained in the steam leaving the installation 1 versus the thermal energy potential contained in the coal being fed to the gasifier as measured by the heat of combustion.

While the present invention has been described with reference to a preferred embodiment, as will occur to those skilled in the art that numerous changes, additions and omissions can be made without departing from the spirit and scope of the present invention as set forth in the appended claims.

We claim:

1. A combined gasification and electric power generation method comprising:
introducing an oxygen product stream and a carbon containing substance into at least one gasifier and gasifying the carbon containing substance to produce a synthesis gas stream comprising hydrogen and carbon monoxide;
treating the synthesis gas stream in a gas conditioning system to produce a fuel stream by removing particulates and sulfur containing compounds from the synthesis gas stream and recovering heat from the synthesis gas stream;
introducing the fuel stream into a combustor of at least one gas turbine;
generating electric power by at least one electric generator coupled to at least one gas turbine;
separating air in a air separation unit by compressing, purifying and cooling the air to a temperature suitable for its rectification in a distillation column system and rectifying the air within the distillation column system to produce the oxygen product stream and a nitrogen containing stream;
the at least one generator generating the electric power at a required power output to at least in part supply an electric power requirement of a captive user and an installation comprising the gasifier, the gas conditioning system, the air separation unit and a nitrogen product compressor;
supplying between 30.0 percent and 60.0 percent of the compressed air required by the air separation unit from a bleed air stream extracted from a compressor of the at least one gas turbine without further compression of the bleed air stream;
compressing at least part of the nitrogen containing stream in the nitrogen product compressor to produce a compressed nitrogen stream;
feeding the compressed nitrogen stream into at least one of the fuel stream, the combustor and a location downstream of the combustor before the expander;
the installation having a design point of ambient temperature and pressure and net power output; and
the at least one gas turbine, at the design point, having a capacity to compress air from the compressor thereof, at a rate between 4.8 and 6.0 times the total molar flow rate of air required by the air separation plant and the compressor of the at least one gas turbine operated at no less than 90.0 percent of the capacity thereof at the design point.

2. The method of claim 1, wherein the electric power requirement of the facility is also supplied by another electric generator coupled to a steam turbine supplied with steam generated in a heat recovery steam generator connected to the at least one gas turbine to receive a gas turbine exhaust stream to produce heat within the heat recovery steam generator.

3. The method of claim 1, wherein the rate is between 4.9 and 5.2 time the total molar flow rate of air required by the air separation plant.

4. The method of claim 1, wherein the bleed air stream supplies 50.0 percent of the compressed air required by the air separation unit.

5. The method of claim 1, wherein the at least part of the nitrogen containing stream has a preselected flow rate that is sufficient to allow the generator to be driven by the gas turbine to generate electric power at the required electric output.

6. The method of claim 1, wherein the nitrogen containing stream has a nitrogen flow rate that is about equal to air flow rate of the bleed air stream.

7. The method of claim 1, wherein the compressed nitrogen stream is heated by the bleed air stream.
